(19) United States
(12) Patent Application Publication
(10) Pub. No.: US 2001/0009037 A1
(43) Pub. Date: Jul. 19, 2001

(54) Recording medium recorded with a program that performs processing depending on a plurality of outputs from pressure-sensitive means, computer that executes the processing and method of using same

(76) Inventor: Nobuhiro Komata, Tokyo (JP)

Correspondence Address: HELFGOTT & KARAS, P.C., 60th FLOOR, EMPIRE STATE BUILDING, NEW YORK, NY, 10118-0110, US

(21) Appl. No.: 09/758,106

(22) Filed: Jan. 10, 2001

(30) Foreign Application Priority Data
Jan. 14, 2000 (JP) 2000-40268

(51) Int. Cl. H04N 7/173; H04N 7/16

(52) U.S. Cl. 725/133; 725/141

(57) ABSTRACT

To provide an easy-to-use user interface in lieu of only pushing or holding down a simple ON/OFF switch by a user, a computer is provided that performs processing by taking as instructions an output from a controller coupled to the computer. The controller has at least two or more pressure-sensitive units, and performs data processing depending on the outputs from the two or more pressure-sensitive units.

### FIELD OF THE INVENTION

The present invention relates to a recording medium recorded with a program that performs processing depending on a plurality of outputs from a pressure-sensitive unit provided in a controller of a computer that executes this processing and method of using same.

### BACKGROUND OF THE INVENTION

In order to play game software running on a computer or a video game machine, a keyboard, a controller, a pointing device or other control means is required. By operating such control means, it is possible to move objects on the screen or perform other such manipulation.

Each of these control means comprises ON/OFF switches, rotary switches or other switches.

The movement of objects, for example, is performed continuously by keeping ON an ON/OFF switch of the controller connected to the video game machine, namely, by holding it down by a user.

For example, there is disclosure of a pressure-sensitive type controller in the publication of examined Japanese utility model application No. JP-B-H1-40545, wherein pressure-sensitive output is provided as input to a VCO (variable control oscillator) and the output of the VCO is used for repeated fire in a game.

### SUMMARY OF THE INVENTION

It is an object of the present invention to make such pushing or holding down of a simple ON/OFF switch by a user into an easier-to-use interface for users.

This and other objects of the present invention are attained by a recording medium according on which is recorded a computer-readable and executable software program that performs processing by taking as instructions the output from a controller which has pressure-sensitive means, wherein the software program comprises a processing program that performs processing depending on at least two outputs of said controller.

A computer according to the present invention performs processing by taking as instructions the output from a controller, and the controller comprises at least two or more pressure-sensitive means, and performs data processing depending on the outputs from the two or more pressure-sensitive means.

A method of using a computer according to the present invention uses a computer that performs processing by taking as instructions the output from a controller, and comprises the steps of: detecting a pushing pressure of a user by at least two or more pressure-sensitive means of the controller, and generating a respective pressure-sensitive output, and performing data processing depending on the outputs from the two or more pressure-sensitive means.

### BRIEF DESCRIPTION OF THE DRAWINGS

FIG. 1 is a schematic diagram showing connection of a controller to an entertainment system in order to enable a user of the entertainment system to enjoy game software or videos;

FIG. 2A shows an example of a screen display in a tightrope walking game;

FIG. 2B shows an example of a display screen in a game wherein an object is moved;

FIG. 3 is a flowchart of the processing of a game which includes a program for performing processing using an output of at least two or more pressure-sensitive switches of the example of FIG. 2A;

FIG. 4 is a flowchart of the processing of a game which includes a program for performing processing using the output of at least two or more pressure-sensitive switches of the example of FIG. 2B;

FIG. 5 is a perspective view showing the controller connected to the entertainment system;

FIG. 6 is a block diagram showing the entertainment system;

FIG. 7 is a top view of a controller;

FIG. 8 is an exploded perspective view showing an embodiment of the constitution of the second control part of the controller;

FIGS. 9A-9C are cross-sectional views of the second control part of FIG. 8;

FIG. 10 is a diagram showing an equivalent circuit for a pressure-sensitive device;

FIG. 11 is a block diagram of the main parts of the controller;

FIG. 12 is an exploded perspective view showing an embodiment of the constitution of the first control part of the controller;

FIG. 13 is a cross-sectional view of the first control part of FIG. 12;

FIG. 14 is a diagram showing the circuit configuration of a resistor;

FIG. 15 is a graph showing the characteristic of the signal output;

FIG. 16 is a block diagram schematically showing the overall constitution including the resistor;

FIG. 17 is an exploded perspective view showing an embodiment of the constitution of the third control part of the controller.

### DETAILED DESCRIPTION OF THE PREFERRED EMBODIMENT

In the present embodiment, various types of processing are performed depending on two pressure-sense values output when at least two pressure-sensitive switches of a controller which has pressure-sensitive devices are operated. Thereby, it is possible to provide a system with a user interface that is improved in comparison to when a single pressure-sensitive switch is used.

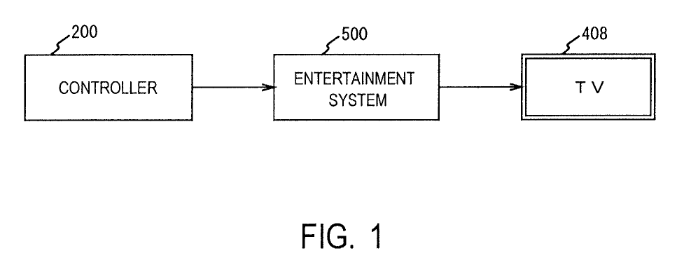

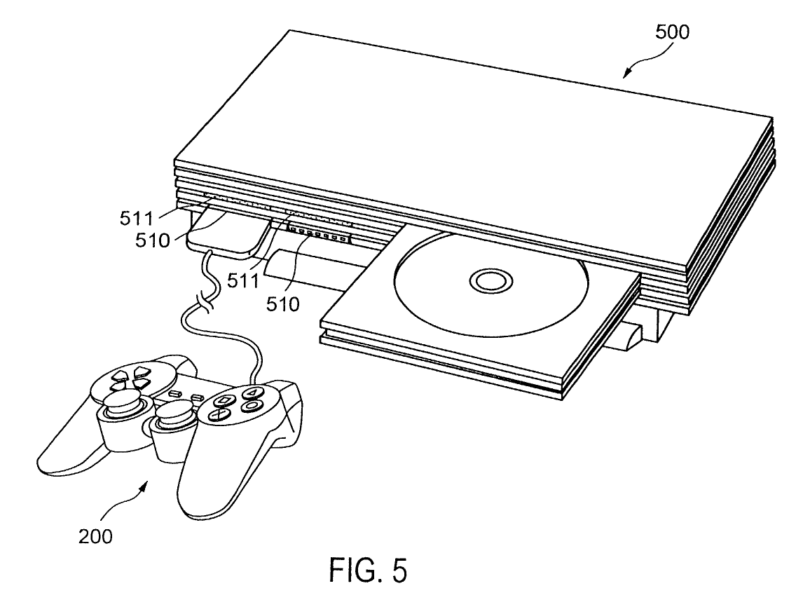

FIG. 1 is a schematic diagram showing connection of a controller to an entertainment system so that a user can enjoy game software or video. More specific structures are shown in FIG. 5 and other figures of the drawings.

As shown in this FIG. 1, a controller 200 which has buttons connected to pressure-sensitive devices positioned within the controller is connected to an entertainment system 500 used for playing games or enjoying DVD video or other types of video images, and the video output terminals are connected to a television monitor 408. Here, the analog output from the pressure-sensitive devices is converted by an A/D converter to digital values in the range 0-255 and provided to the entertainment system 500.

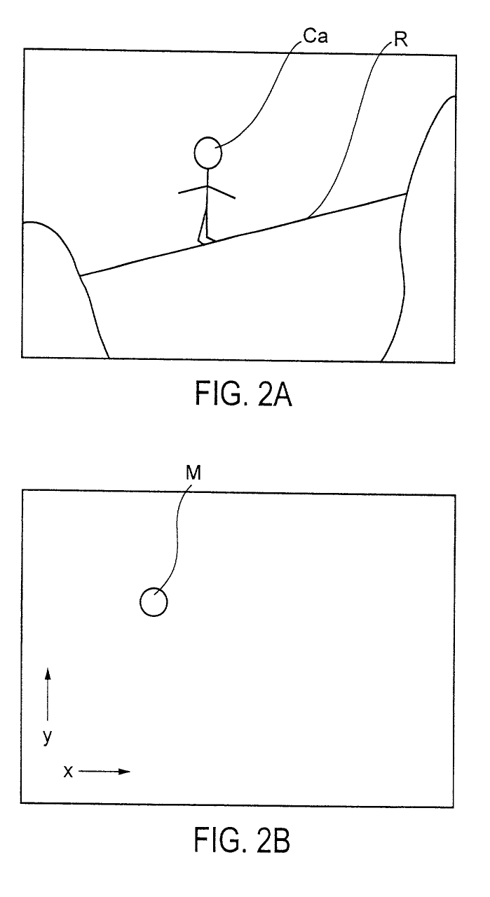

With reference to FIGS. 2-4, here follows a description of the case wherein processing is performed depending on the operation of at least two pressure-sensitive switches of the controller 200.

FIG. 2A shows an example of a screen display in a tightrope walking game, for example. FIG. 2B shows an example of a display screen in a game wherein an object M is moved. In both games, at least two or more pressure-sensitive switches are used.

In the tightrope walking game shown in FIG. 2A, for example, one pressure-sensitive switch each may be pressed with the left and right hands, for example, and while keeping the differential between the outputs of these two pressure-sensitive switches within a stipulated range, a different switch may be pushed to make the character Ca move across the rope R.

In addition, in the movement game shown in FIG. 2B, for example, one pressure-sensitive switch each may be pressed with the left and right hands, for example, so the object is moved in the x direction based on the output value of the pressure-sensitive switch for the x direction, and the object is moved in the y direction based on the output value of the pressure-sensitive switch for the y direction.

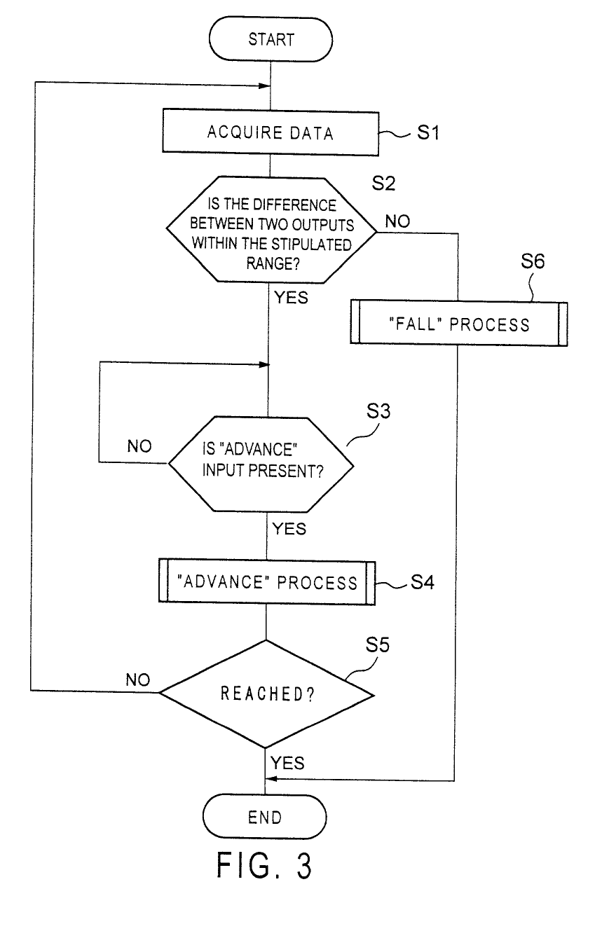

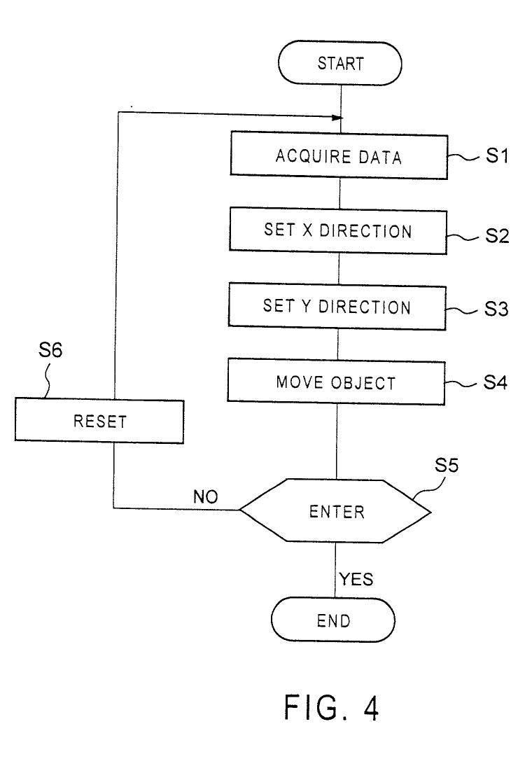

Next, in reference to FIGS. 3 and 4, the games shown in both FIGS. 2A and B, respectively, will be described. The flowcharts shown in FIGS. 3 and 4 each show the processing of a game that includes a program for performing processing using the outputs of at least two or more pressure-sensitive switches. The program for performing processing using the outputs of at least two or more pressure-sensitive switches may be supplied either recorded alone upon an optical disc or other recording medium, or recorded upon said recording medium together with the game software as part of the game software. Such programs are run by the entertainment system 500 and executed by its CPU.

First, the tightrope walking game in reference to FIG. 3 will be explained.

In Step S1, two pressure-sense values are acquired from the controller 200, and in Step S2, a decision is made as to whether or not the difference between the two pressure-sensing values thus acquired is within a stipulated range, and if “YES” then control processing moves to Step S3, but if “NO” then a “fall” process is performed. The “fall” process has the meaning of showing the character Ca falling from the rope, displayed as animation.

Here, the stipulated range can be gradually made more narrow, for example, as the levels advance in the tightrope walking game. For example, the stipulated range may be 20 on the first level, 10 on the next level and so on, gradually becoming narrower, so the user must make the pressure at which the pressure-sensitive switches are pushed with both fingers equal or fall. The differential between the output values of the individual pressure-sensitive switches pushed is found and, after correction if necessary, then compared against the stipulated range.

In Step S3, a decision is made as to whether or not input indicating “advance” is present and if “YES” then in Step S4 the “advance” process is performed, namely, showing the character Ca moving upon the rope R, displayed as animation, and the distance moved is stored.

In Step S5, the distance moved thus stored is compared against the overall distance, and if the stored distance moved is equal to or greater than the overall distance, then the end has been reached, so a decision of “YES” results and this level ends, but if “NO” then control processing moves back to Step S1.

Next, the movement game in reference to FIG. 4 will be explained.

In Step S1, two pressure-sensing values are acquired from the controller 200, In Step S2, an address depending on the pressure-sensing value for the x direction is set. In Step S3, an address depending on the pressure-sensing value for the y direction is set. Note that the pressure-sense values are in the range 0-255, so if the maximum values in both directions are 255, then the same value is used as the address, but if greater than 255, then an address of a stipulated multiple with respect to a unit pressure-sense value is given. For example, if the maximum value of the addresses in the x and y directions is 2550, then an address of 10 is given to a pressure-sensing value of 1. Thus, in this case, the stepping of addresses is 10 each.

In Step S4, the object M is moved to the position indicated by the addresses specified by each of the pressure-sense values in the x direction and y direction. In Step S5, a decision is made as to whether or not there is input from the user which indicates “enter,” and if “YES” then end, but if “NO” then in Step S6, the addresses are reset and control moves back to Step S1.

In addition, while the examples described above described processes where the output of two pressure-sensitive switches is applied to a tightrope walking game or movement game, by using three pressure-sensitive switches, it is possible to move an object in three-dimensional space, for example, in the x, y and z directions.

Note that rather than the magnitude of the pressure-sense value of the pressure-sensitive switch, it is also possible to find the percent change from the previous pressure-sensing value to the current pressure-sense value, and perform the movement at an incremental movement which depends on this percent change. For example, if the previous pressure-sensing value is 100 and the current pressure-sensing value is 50, then the percent change is 50%, so the incremental movement may be made ½the previous.

As described above, with the present embodiment, processing is performed depending on the output of two or more pressure-sensitive switches, so it is possible to improve the game play of games having processing programs using the output of one pressure-sensitive switch, and thus improve the user interface.

It should be noted that while in the aforementioned examples, the processing using the output of two or more pressure-sensitive switches was explained with examples of application to a tightrope walking game and movement game, it need not be said that it is also applicable to any kind of game that requires processing using the output of two or more pressure-sensitive switches, including role-playing games, for example.

FIG. 5 is a perspective view showing the controller 200 connected to entertainment system 500. The controller 200 is removably connected to the entertainment system 500, and the entertainment system 500 is connected to television monitor 408.

The entertainment system 500 reads the program for a computer game from recording media upon which that program is recorded and by executing the program displays characters on the television monitor 408. The entertainment system 500 has also various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters displayed on the television monitor 408 in the directions up, down, left or right.

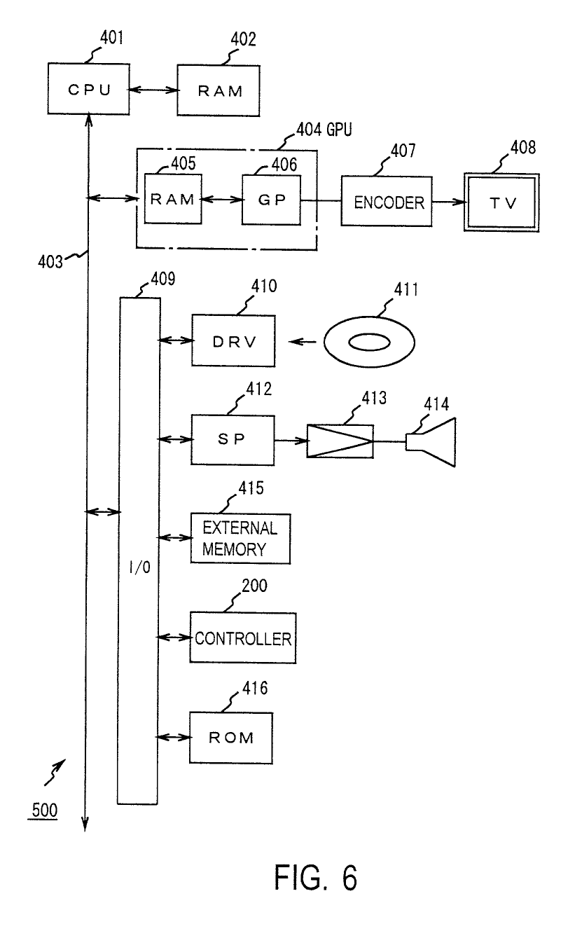

With reference to FIG. 6, here follows a description of the interior of the entertainment system 500 shown in FIG. 5. FIG. 6 is a block diagram of the entertainment system 500.

A CPU 401 is connected to RAM 402 and a bus 403, respectively. Connected to bus 403 are a graphics processor unit (GPU) 404 and an input/output processor (I/O) 409, respectively. The GPU 404 is connected via an encoder 407 for converting a digital RGB signal or the like into the NTSC standard television format, for example, to a television monitor (TV) 408 as a peripheral.

Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via a connector 511 to the entertainment system 500 shown in FIG. 5. The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the Ram 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X, Y, Z coordinates values are modified variously. The modified polygon vertex data is subjected to perspective conversion processing and converted into two-dimensional coordinate data.

The regions specified by two-dimensional coordinates are so-called polygons. The converted coordinate data, Z data and texture data are supplied to the GPU 404. Based on this converted coordinate data, Z data and texture data, the GPU 404 performs the drawing process by writing texture data sequentially into the RAM 405. One frame of image data upon which the drawing process is completed, is encoded by the encoder 407 and then supplied to the television monitor 408 and displayed on its screen as an image.

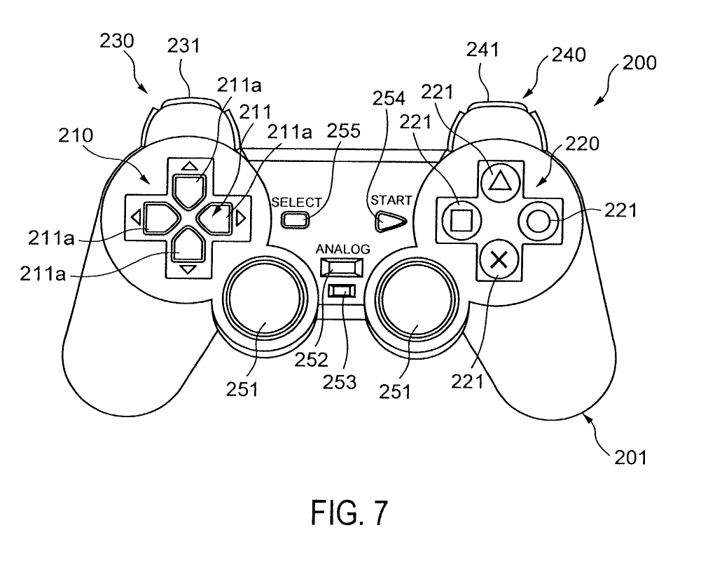

FIG. 7 is a top view of controller 200. The controller 200 consists of a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control The individual control buttons 221 have identifying marks such as “∘” (circle), “×” (cross), “Δ” (triangle) and “□” (quadrangle) on their tops, in order to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded upon the optical disc, and may be allocated functions for making the game characters do special actions, for example.

Moreover, two joy sticks 251 for performing analog operation are provided upon the unit body 201 shown in FIG. 7. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like.

Controller 200 is held by the left hand and the right hand of a user and is operated by the other fingers of the user, and in particular the user's thumbs are able to operate most of the buttons on the top surface.

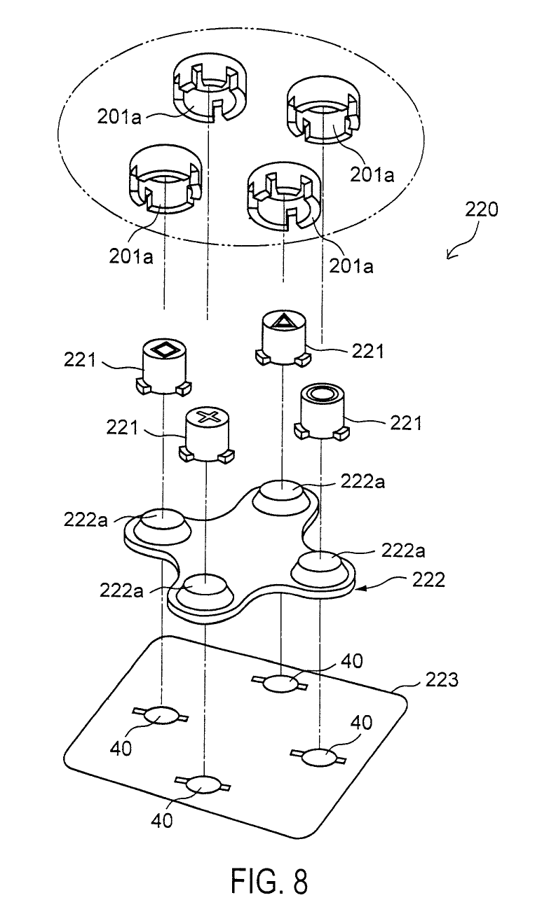

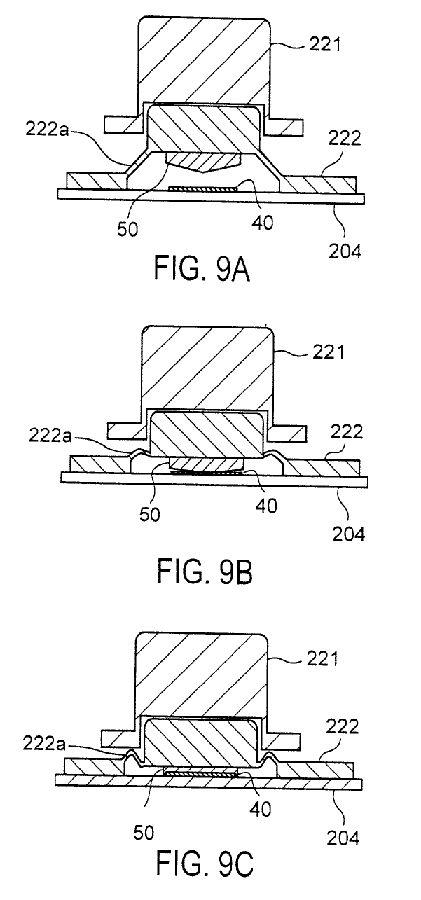

FIG. 8 and FIGS. 9A-9C are, respectively, an exploded perspective view and cross-sectional views showing the second control part of the controller.

As shown in FIG. 8, the second control part 220 consists of four control buttons 221 which serve as the control elements, an elastic body 222, and a sheet member 223 provided with resistors 40. The individual control buttons 221 are inserted from behind through insertion holes 201a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the included-surfaced portions of these elastic areas 222a flex so that the upper walls move together with the control buttons 221. On the other hand, when the pushing pressure on the control buttons 221 is released, the flexed inclined-surface portions of elastic areas 222a elastically return to their original shape, pushing up the control buttons 221.

The elastic body 222 functions as a spring means whereby control buttons 221 which had been pushed in by a pushing action are returned to their original positions. As shown in FIGS. 9A-9C conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222. The resistors 40 and conducting members 50 form pressure-sensitive devices. These pressure-sensitive devices consisting of resistors 40 and conducting members 50 have resistance values that vary depending on the pushing pressure received from the control buttons 221.

To describe this in more detail, as shown in FIGS. 9A-9C, the second control part 220 is provided with control buttons 221 as control elements, an elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIGS. 9B and 9C, the surface area in contact with the resistor 40 varies depending on the pressure. To wit, when the pressing force on the control button 221 is weak, as shown in FIG. 9B only the area near the conical tip of the conducting member 50 is in contact. As the pressing force on the control button 221 becomes stronger, the tip of the conducting member 50 deforms gradually so the surface area in contact expands.

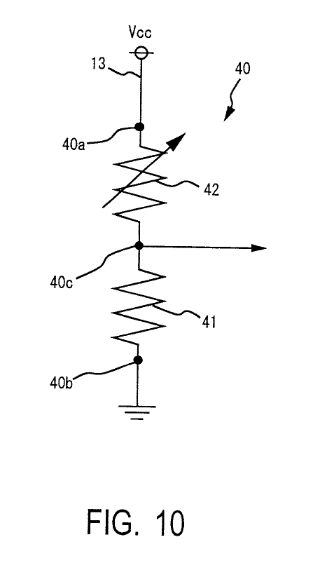

FIG. 10 is a diagram showing an equivalent circuit for a pressure-sensitive device consisting of a resistor 40 and conducting member 50. As shown in this diagram, the pressure-sensitive device is inserted in series in a power supply line 13, where the voltage V_{cc} is applied between the electrodes 40a and 40b. As shown in this diagram, the pressure-sensitive device is divided into a variable resistor 42 that has the relatively small resistance value of the conducting member 50, and a fixed resistor 41 that has the relatively large resistance value of the resistor 40.

Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

When the conducting member 50 comes into contact with the resistor 40, in the portion of contact, the conducting member 50 becomes a bridge instead of the resistor 40 and a current flows, so the resistance value becomes smaller in the portion in contact. Therefore, the greater the surface area of contact between the resistor 40 and conducting member 50, the lower the resistance value of the pressure-sensitive device becomes. In this manner, the entire pressure-sensitive device can be understood to be a variable resistor. It should be noted that FIGS. 9A-9C show only the contact portion between the conducting member 50 and resistor 40 which forms the variable resistor 42 of FIG. 10, but the fixed resistor of FIG. 10 is omitted from FIGS. 9A-9C.

In the preferred embodiment, an output terminal is provided near the boundary between the variable resistor 42 and fixed resistor 41, namely near the intermediate point of the resistors 40, and thus a voltage stepped down from the applied voltage V_{cc} by the amount the variable resistance is extracted as an analog signal corresponding to the pushing pressure by the user on the control button 221.

First, since a voltage is applied to the resistor 40 when the power is turned on, even if the control button 221 is not pressed, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ.

If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed.

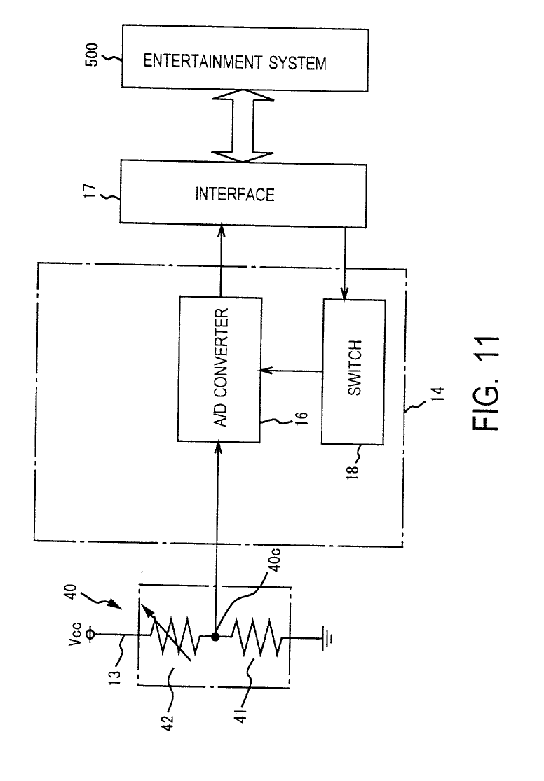

FIG. 11 is a block diagram showing the main parts of the controller 200. An MPU 14 mounted on the internal board of the controller 200 is provided with a switch 18, an A/D converter 15 and two vibration generation systems. The analog signal (voltage) output from the output terminal 40c of the resistor 40 is provided as the input to the A/D converter 16 and is converted to a digital signal.

The digital signal output from the A/D converter 16 is sent via an interface 17 provided upon the internal board of the controller 200 to the entertainment system 500 and the actions of game characters and the like are executed based on this digital signal.

Changes in the level of the analog signal output form the output terminal 40c of the resistor 40 correspond to changes in the pushing pressure received form the control button 221 (control element) as described above.

Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411.

When a game program recorded on optical disc is executed by the entertainment system 500, depending on the content of the game program, a control signal is provided as output to specify whether the A/D converter 16 is to function as a means of providing output of a multi-valued analog signal, or as a means of providing a binary digital signal. Based on this control signal, the switch 18 is switched to select the function of the A/D converter 16.

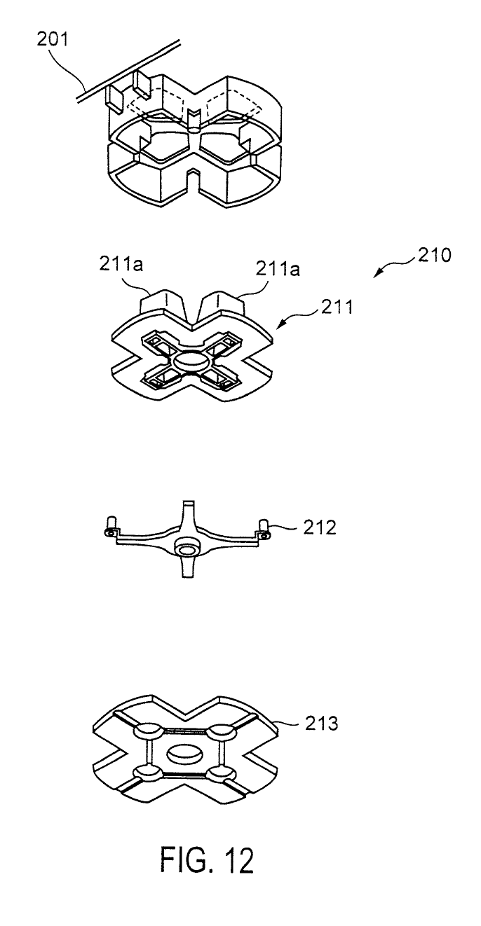

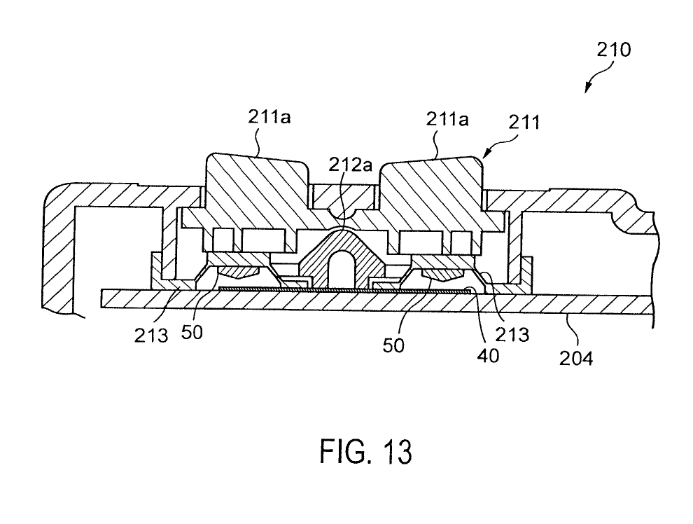

FIGS. 12 and 13 show an example of the configuration of the first control part of the controller.

As shown in FIG. 12, the first control part 210 includes a cruciform control unit 211, a spacer 212 that positions this control unit 211, and an elastic body 213 that elastically supports the control unit 211. Moreover, as shown in FIG. 13, a conducting member 50 is attached to the rear surface of the elastic body 213, and the configuration is such that resistors 40 are disposed at the positions facing the individual control keys 211a (control elements) of the control unit 211 via the elastic body 213.

The overall structure of the first control part 210 has already been made public knowledge in the publication of unexamined Japanese patent application No. JP-A-H8-163672. The control unit 211 however, uses a hemispherical projection 212a formed in the center of the spacer 212 as a fulcrum, and the individual control keys 211a (control elements) are assembled such that they can push on the resistor 40 side (see FIG. 13).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 211a which are control elements are pushed, the pushing pressure acts via the elastic body 213 on the pressure-sensitive devices consisting of a conducting member 50 and resistor 40, so that its electrical resistance value varies depending on the magnitude of the pushing pressure.

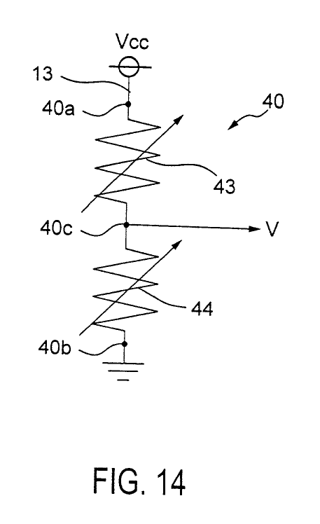

FIG. 14 is a diagram showing the circuit configuration of the resistor. As shown in this diagram, the resistor 40 is inserted in series in a power supply line 13, where a voltage is applied between the electrodes 40a and 40b. The resistance of this resistor 40 is illustrated schematically, as shown in this diagram, the resistor 40 is divided into first and second variable resistors 43 and 44. Among these, the portion of the first variable resistor 43 is in contact, respectively, with the conducting member 50 that moves together with the control key (up directional key) 211a for moving the character in the up direction, and with the conducting member 50 that moves together with the control key (left directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down directional key) 211a for moving the character in the down direction, and with the conducting member 50 that moves together with the control key (right directional key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is provided as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{cc} is the power supply voltage, then the output voltage V appearing at the output terminal 40c can be expressed by the following equation.

V=V_{cc}×R2/(R1+R2)

Therefore, when the resistance value of the first variable resistor 43 decreases, the output voltage increases, but when the resistance value of the second variable resistor 44 decreases, the output voltage also decreases.

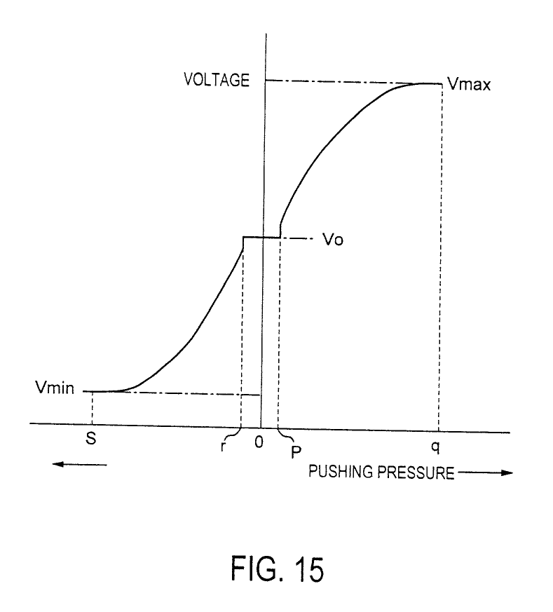

FIG. 15 is a graph showing the characteristic of the analog signal (voltage) output from the output terminal of the resistor.

First, since a voltage is applied to the resistor 40 when the power is turned on, even if the individual control keys 211a of the control unit 211 are not pressed, a fixed analog signal (voltage) V₀ is provided as output from the output terminal 40c (at position 0 in the graph).

Next, even if one of the individual control keys 211a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surface area of contact between the conducting member 50 and the first variable resistor 43 portion increases in response to the pushing pressure on the control key 211a (control elements), and thus the resistance of that portion is reduced so the analog signal (voltage) output from the output terminal 40c of the resistor 40 increases. Furthermore, the analog signal (voltage) output from the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control elements), and thus the resistance of that portion is reduced, and as a result, the analog signal (voltage) output from the output terminal 40c of the resistor 40 decreases. Furthermore, the analog signal (voltage) output from the output terminal 40c of the resistor 40 reaches the minimum Vₘᵢₙ when the conducting member 50 is most deformed (at position s in the graph).

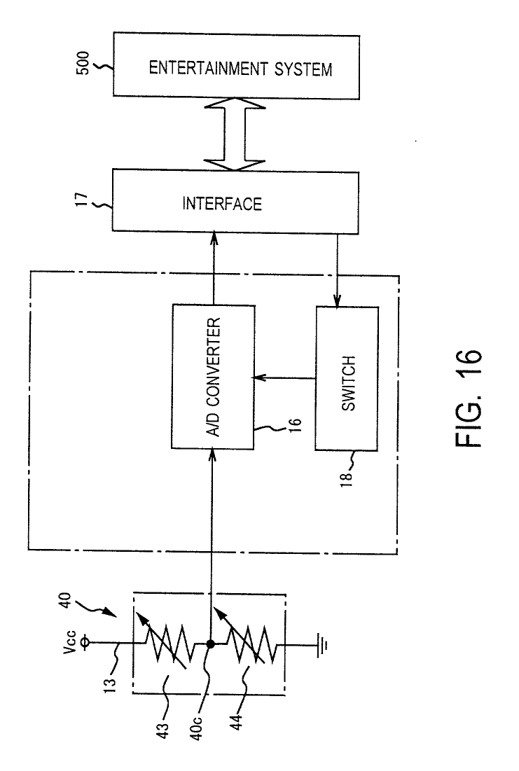

As shown in FIG. 16, the analog signal (voltage) output from the output terminal 40c of the resistor 40 is provided as input to an A/D converter 16 and converted to a digital signal. It is to be noted that the function of the A/D converter 16 shown in FIG. 16 is as described previously based on FIG. 11, so a detailed description shall be omitted here.

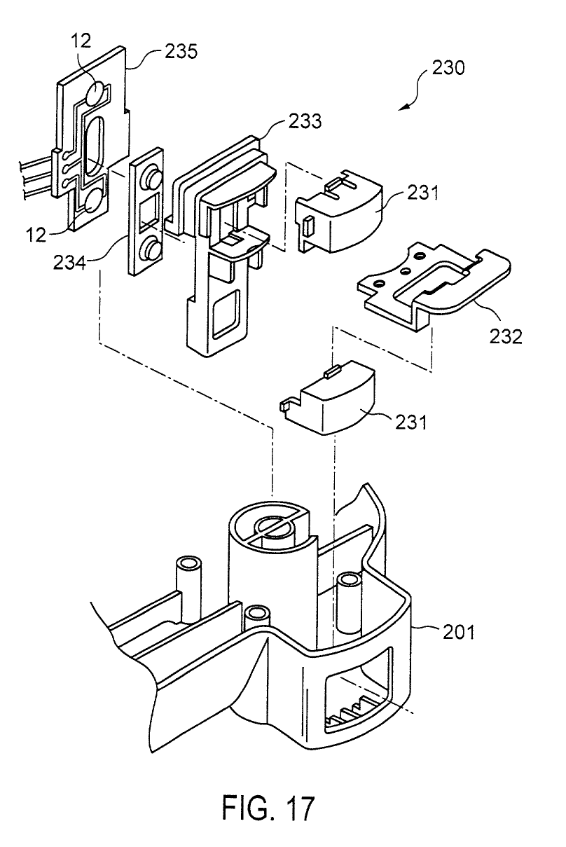

FIG. 17 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JPA-H8-163672, so a detailed description thereof will be omitted. The individual control buttons 231 can be pushed in while being guided by the spacer 232, the pushing pressure when pressed acts via the elastic body 234 on the pressure-sensitive device consisting of a conducting member 50 and resistor 40. The electrical resistance value of the pressure-sensitive device varies depending on the magnitude of the pushing pressure it receives.

It is noted that the fourth control part 240 has the same structure as that of the third control part 230 described above.

While an embodiment was described above, the pressure-sensing value as pushed by the user is used as is. However, in order to correct for differences in the body weights of users or differences in how good their reflexes are, it is possible to correct the maximum value of the user pressure-sensing value to the maximum game pressure-sensing value set by the program, and intermediate values may be corrected proportionally and used. This type of correction is performed by preparing a correction table. In addition, the user pressure-sensing value can be corrected based upon a known function. Moreover, the maximum value of the user pressure-sensing value rate of change may be corrected to the maximum game pressure-sense value rate of change set in the program, and intermediate values can be proportionally corrected and used for more details about this method, refer to the present inventors' Japanese patent application No. 2000-40257 and the corresponding PCT application JP/______ (applicant's file reference SC0097WO00).

By means of this invention, various types of processing are performed depending on two pressure-sensing values outputted when at least two pressure-sensitive switches of a controller which has pressure-sensitive devices are operated, so it is possible to provide a system with a user interface that is improved in comparison to when a single pressure-sensitive switch is used.

1. A recording medium on which is recorded a computer-readable and executable software program that performs processing by taking as instructions an output from a controller which has pressure-sensitive means which senses a pushing pressure of a user on the controller, wherein said software program comprises a processing program that performs processing depending on at least two outputs of said controller.

2. The recording medium according to claim 1, the processing is performed depending on the rate of change per unit time of output values of said controller.

3. The recording medium according to claim 1, the processing is performed depending on a differential between at least two output values of said controller.

4. The recording medium according to claim 1 wherein
said software program is a tightrope walking game, and
at the time when two pressure-sensitive means provided in the controller, are pushed by the user, a differential between two outputs of said two pressure-sensitive means is kept within a stipulated range while a further pressure-sensitive means of the controller is pushed to move a character upon a rope.

5. The recording medium according to claim 1, wherein
said software program is a movement game, and
at the time when two pressure-sensitive means provided in the controller, are pushed by the user, an object on a screen is moved in the x direction based on an output value of one of said two pressure-sensitive means, and the object is moved in the y direction based on an output value of another of said two pressure-sensitive means.

6. A computer that performs processing by taking as instructions an output from a controller, comprising:
said controller which includes at least two pressure-sensitive means, so that the computer performs data processing depending on two outputs from said at least two pressure-sensitive means.

7. The computer according to claim 6, wherein the data processing is performed depending on the rate of change per unit time of output values of said controller.

8. The computer according to claim 6, wherein the data processing is performed depending on a differential between at least two output values of said controller.

9. The computer according to claim 6, wherein
a software program used thereby is a tightrope walking game, and
at the time when two pressure-sensitive means are pushed by a user, differential between two outputs of said two pressure-sensitive means is kept within a stipulated range while a further pressure-sensitive means provided in said controller is pushed by the user to move a character on a screen upon a rope.

10. The computer according to claim 6, wherein
a software program used thereby is a movement game, and
at the time when two pressure-sensitive means are pushed by a user, an object on a screen is moved in the x direction based on an output value of one of said two pressure-sensitive means, and the object is moved on the screen in the y direction based on an output value of another of said two pressure-sensitive means.

11. A method of performing data processing, using a computer that performs processing by taking as instructions an output from a controller, comprising the steps of
detecting a pushing pressure of a user on the controller by at least two or more pressure-sensitive means included in said controller, and generating respective pressure-sensitive outputs; and
performing data processing depending on the outputs from said two or more pressure-sensitive means.

12. The method according to claim 11, wherein,
in said data processing step, processing is performed depending on a differential between at least two output values of said controller.

13. The method according to claim 11, wherein
a software program used by the computer is a tightrope walking game, and
at the time when two pressure-sensitive means are pushed by the user, a differential between the outputs of said two pressure-sensitive means is kept within a stipulated range while a further pressure-sensitive means is pushed by the user to move a character on a screen upon a rope.

14. The method according to claim 11, wherein
a software program used by the computer is a movement game, and
at the time when two pressure-sensitive means are pushed by the user, an object on a screen is moved in the x direction based on an output value of one of said two pressure-sensitive means, and the object is moved on the screen in the y direction based on an output value of another of said two pressure-sensitive means.
